(19) United States
(12) Patent Application Publication
(10) Pub. No.: US 2026/0036157 A1
(43) Pub. Date: Feb. 5, 2026

(54) Systems and Methods for Open-end Keyhole Connector Implementation

(71) Applicants: Yanisa Techagumthorn, Brooklyn, NY (US); Pitak Techagumthorn, Lynnwood, WA (US)

(72) Inventors: Yanisa Techagumthorn, Brooklyn, NY (US); Pitak Techagumthorn, Lynnwood, WA (US)

(21) Appl. No.: 19/278,758

(22) Filed: Jul. 23, 2025

Related U.S. Application Data
(60) Provisional application No. 63/677,393, filed on Jul. 30, 2024.

(51) Int. Cl. F16B 19/00

(52) U.S. Cl. CPC F16B 19/00

(57) ABSTRACT

A connection system comprises at least one open-end keyhole connector with an open pathway from its edge to its inner hole and a connecting hub further comprising a housing body and a lock pin with at least one groove. The lock pin has the ability to shift along its axis to align its grooves with designated spaces for the connector in the housing body and/or the ability to rotate around the axis to align the orientation of its grooves with the open pathway on the connector, which enables the connector to connect/disconnect with the hub without needing to disassemble the lock pin. For a hub handling multiple connectors, a space retainer is added between each of the spaces designated for each connector in the housing body. An embodiment with additional rotation control and detent mechanisms is also disclosed in this invention.

### CROSS-REFERENCE TO RELATED APPLICATIONS

This application claims the benefit of U.S. Provisional Patent Application No, 63/677,393, filed Jul. 30, 2024, which is incorporated by reference herein its entirety.

### PRIOR ART DOCUMENTS

[Patent Document 1] Folding Multi Saw Publication No. US2018/0099339 A1;
[Patent Document 2] Modular Tool Apparatus Publication No. US2021/0245352 A1;
[Patent Document 3] Folding Knife with Removable Blade Patent No. U.S. Pat. No. 7,370,421 B2;
[Patent Document 4] Handle Assembly For A Foldable Saw U.S. Pat. No. 5,979,065;
[Patent Document 5] Knife With Removable Blade U.S. Pat. No. 4,233,737.

### FIELD OF THE INVENTION

This invention relates to systems and methods to handle connections of at least one flat connector featuring a hole with a host unit equipped with a lock pin.

### BACKGROUND OF THE INVENTION

To connect something equipped with a flat connector that features an inner hole to some sort of host unit, typically the flat connector is secured via the hole onto the host unit using a lock pin kit, similar to the way a washer is secured by a set of bolt and nut fasteners. An operation to disconnect or reconnect the holed connector usually starts with disassembling the lock pin from the host unit to disengage the holed connector. After the operation is finished, to establish the secured connection again, the lock pin must be reassembled.

In contrast, some connection systems choose to use open-end keyhole connectors, a particular type of holed connector that features an open pathway from its edge to its inner hole. In conjunction with a suitably designed lock pin kit, such a connection system allows the open-end keyhole connector to move into and out of connection via its open pathway, perpendicular to the longitudinal axis of the lock pin. Thus, disassembling the lock pin from the host unit is no longer a prerequisite for the operation to disconnect or reconnect the open-end keyhole connector.

For example, as disclosed in the list of prior arts, manufacturers of folding tools such as folding pocketknives or folding saws have incorporated various designs of open-end keyhole connectors into the tang of some of their blades. In conjunction with a specially designed lock pin kit, they have launched a variety of folding tools that feature interchangeable components available in the market today. However, most of these products tend to work with just one connector. Those that can accommodate multiple connectors tend to only offer one action for all connectors at once. More specifically, once the disconnection/reconnection mechanism is active, every single connector has the identical opportunity to disconnect or reconnect. There is no ability to pinpoint control over one specific member of the group of connectors during this operation.

What is desired, then, is an improved set of systems and methods for open-end keyhole connector implementation that, among other things, provides a connecting hub to accommodate multiple connectors in a way that allows the user to control each connector independently.

### SUMMARY OF THE INVENTION

The primary objective of the present invention is to offer an improved set of systems and methods for open-end keyhole connector implementation. This invention comprises a minimum of one open-end keyhole connector and a connecting hub further comprising a lock pin and a housing body.

While this invention can result in many different system configurations, the drawings and descriptions in this disclosure are based on a preferred embodiment configured with a connecting hub that is capable of handling up to three open-end keyhole connectors. In this embodiment, the preferred movement direction of the open-end keyhole connectors to connect/disconnect with the connecting hub is in the direction perpendicular to the side panel of the housing body. Additionally, there may be objects attached to the open-end keyhole connectors or to the connecting hub to reap the benefits of this connection system in a practical use case, but that matter is not in the scope of this patent application.

The preferred embodiment is presented with the open-end keyhole connector featuring an open pathway cutout from its edge to its inner hole, in conjunction with the connecting hub comprising a lock pin featuring three pairs of grooves and a housing body featuring two space retainers defining three designated spaces for the connectors and a series of holes to accommodate the lock pin. The lock pin has the ability to shift along its longitudinal axis to alter the position of its grooves in reference to the designated spaces for the connectors in the housing body and/or the ability to rotate around the axis to alter the orientation of its grooves in reference to the open pathways on the connectors. The shifting and/or rotating actions of the lock pin in the housing body govern the state of connection between the open-end keyhole connectors and the connecting hub. Only when the lock pin has, at the same time, the position of its grooves aligned with the designated spaces in the housing body and the orientation of its grooves aligned with the open pathway on the open-end keyhole connector, then, can the open-end keyhole connector connect/disconnect with the connecting hub via its open pathway in the direction perpendicular to the axis of the lock pin, without needing to disassemble the lock pin from the connecting hub.

Moreover, an ability to control the rotating action of the open-end keyhole connectors around the lock pin can be achieved by adding a rotation control pin to a connecting hub that has an additional series of holes in the housing body to accommodate the rotation control pin, and by also adding a series of rotation catch cutouts along the edge of the open-end keyhole connectors. The rotation control pin has a series of grooves with similar spacing along its axis as the lock pin and also has the ability to shift along its axis while being in the connecting hub. Only when the rotation control pin has its grooves aligned with the designated spaces for the connectors in the housing body, then, can the open-end keyhole connectors with rotation catches rotate around the lock pin in the connecting hub. Lastly, detent units and detent catches can also be added to the housing body and the open-end keyhole connector, respectively, to provide tactile feedback during the operation of the system.

### BRIEF DESCRIPTION OF DRAWINGS

FIG. 1 is a perspective view of the preferred embodiment of the connection system, wherein the open-end keyhole connector is connected with the connecting hub comprising a lock pin and a housing body.

FIG. 2 is an exploded view of each component of the connection system in FIG. 1 in full view.

FIG. 3 is a perspective view of the open-end keyhole connector and the lock pin, two components of the connection system in FIG. 1.

FIGS. 4A-4F are perspective views of six example variants of the open-end keyhole connector and the lock pin in FIG. 3, with the lock pin shown as a cross-section view taken along line C-C.

FIG. 5 is a perspective view of the embodiment in FIG. 1, where the housing body and space retainers are shown partially sectioned along line A-A and the open-end keyhole connector is shown partially sectioned along line B-B, exhibiting the interlocking connections of the components in the connection system.

FIG. 6 illustrates when the embodiment in FIG. 5 has the lock pin rotated by one-eighth of a turn around its axis.

FIG. 7 illustrates when the embodiment in FIG. 5 has the lock pin rotated by one-quarter of a turn around its axis.

FIG. 8 illustrates when the embodiment in FIG. 5 has the lock pin rotated by three-eighths of a turn around its axis.

FIG. 9 illustrates when the embodiment in FIG. 8 has the lock pin shifted upwards along its axis and the open-end keyhole connector (shown in full view) is disconnected.

FIGS. 10A-10C are perspective views of three variants of the lock pin. FIG. 10A shows the lock pin of the embodiment in FIG. 1. FIG. 10B shows a variant with three pairs of grooves with identical orientations, and FIG. 10C shows a variant where the orientations of the grooves are adjustable.

FIG. 11 is a partially sectioned perspective view of an embodiment similar to the one in FIG. 5, but with its lock pin replaced with the one shown in FIG. 10B.

FIG. 12 illustrates when the embodiment in FIG. 11 has the lock pin rotated by one quarter of a turn.

FIG. 13 illustrates when the embodiment in FIG. 12 has the lock pin shifted upwards along its axis and the open-end keyhole connector (shown in full view) is disconnected.

FIG. 14 illustrates an embodiment that takes the basic configuration from FIG. 1 with additions of a rotation control pin and detent units to the connecting hub as well as additions of rotation catch cutouts and detent catches to the open-end keyhole connector.

FIG. 15 is an exploded view of each component of the embodiment in FIG. 14.

FIG. 16 is a perspective view of the embodiment in FIG. 14 without the top panel of the housing body, where the housing body and space retainers are shown partially sectioned along line D-D, exhibiting a secured connection with a rotation blockage scenario.

FIG. 17 illustrates when the embodiment in FIG. 16 has the rotation control pin shifted downwards along its axis, eliminating the rotation blockage.

FIG. 18 illustrates when the rotation blockage is eliminated in FIG. 17 allowing the open-end keyhole connector to rotate a few degrees around the lock pin.

FIG. 19 illustrates when the open-end keyhole connector in FIG. 18 rotates further until the rotation catch cutout aligns with the rotation control pin which shifts back upward to reinstate the rotation blockage.

### DETAILED DESCRIPTION OF THE INVENTION

The accompanying drawings are for the purpose of describing the present invention and depict only typical embodiments. The drawings are not intended to limit the scope of the present invention, nor are they necessarily drawn to scale or in proper proportion.

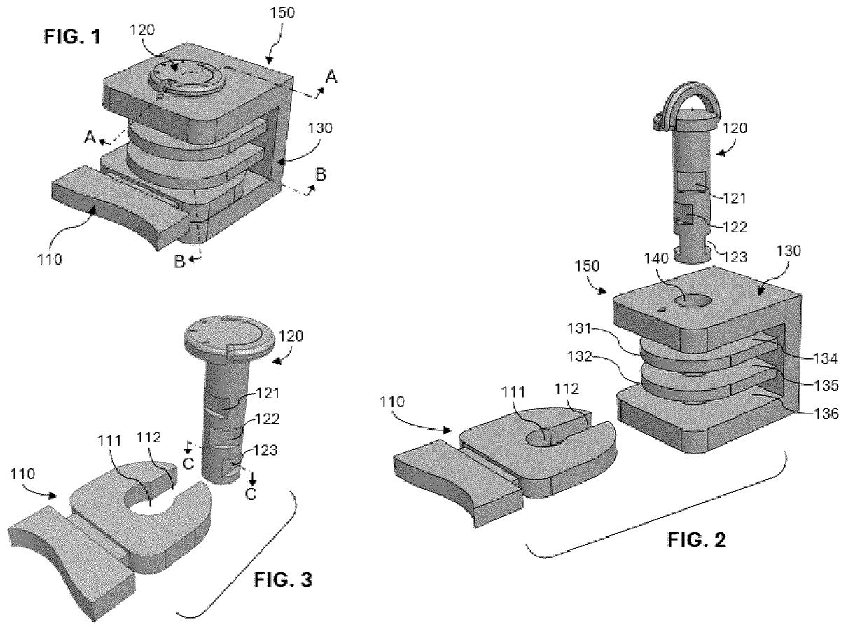

The present invention is a connection system as shown in FIG. 1 comprising at least one open-end keyhole connector 110 and a connecting hub 150 further comprising a lock pin 120 and a housing body 130.

As shown in the exploded view FIG. 2, the open-end keyhole connector 110 is a particular type of keyhole connector that features an open pathway 112 from its edge to its inner hole 111. The open-end keyhole connector 110 connects and disconnects from the connecting hub 150 via this open pathway 112. The lock pin 120 has three groove pairs 121, 122, 123, with each groove placed perpendicular to the longitudinal axis of the pin. The housing body 130 has a top panel, bottom panel, and side panel, plus two space retainers 131, 132 affixed to the side panel. The space retainers help to allocate and retain three designated spaces 134, 135, 136 for open-end keyhole connectors and to keep each connector separate from each other. The housing body 130 and space retainers 131, 132 also have a series of holes 140 to accommodate the lock pin 120. While the connection system shown in this view can hold up to three open-end keyhole connectors, only one 110 is shown so that the components of each of the drawings can be shown more clearly.

FIG. 3 illustrates how the groove pairs 121, 122, 123 create thinner cores on the lock pin 120 with different orientations around its axis, and the open pathway 112 has a narrower opening than the inner hole 111 of the open-end keyhole connector 110. When the lock pin has the position of its grooves along its axis aligned with the stack layout of the designated spaces in the housing body, only the groove pair that has its orientation aligned with the open pathway of the connector can let the connector slide into or out of the lock pin. In this example, only the groove pair 123 allows the connector 110 to slide, via open pathway 112, into or out of the lock pin 120.

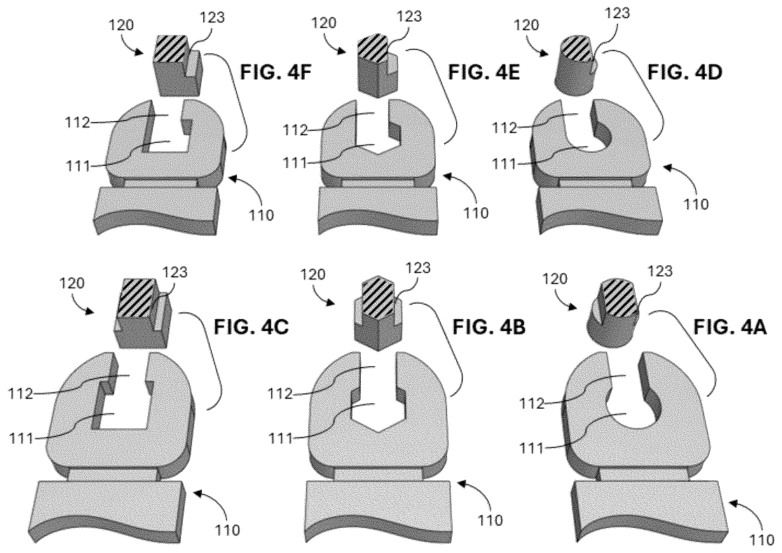

As shown in FIGS. 4A-4F, the open-end keyhole connector and lock pin can take many forms. Illustrated are six example variants of open-end keyhole connectors 110 along with the cross sections of corresponding lock pins 120. FIG. 4A shows the same connector 110 as in FIG. 3 and the cross section of the lock pin 120 taken along line C-C, where the inner hole 111 of the connector and the shaft of the lock pin 120 are round, and the open pathway 112 and the cross section of the groove pair 123 are symmetrical in reference to the inner hole 111 and the axis of the lock pin 120 respectively. FIGS. 4B and 4C show examples of symmetrical, non-rounded shape such as hexagonal and square variants of the components respectively, and FIGS. 4D-4F show examples of asymmetrical variants of the components in FIG. 4A-4C respectively.

The positional and orientational alignments of the grooves on the lock pin govern the ability of the open-end keyhole connector to connect/disconnect with the connecting hub, as shown in FIGS. 5-9, which are partially sectioned views of the embodiment in FIG. 1; the top panel of the housing body and the space retainers are sectioned along line A-A and the open-end keyhole connector is sectioned along line B-B, except in FIG. 9 where the connector is shown in full view.

In FIG. 5, the lock pin 120 is in its base position in the housing body 130, and the open-end keyhole connector 110 is connected into the bottom designated space 136 of the housing body 130. None of the groove pairs 121, 122, 123 on the lock pin has its orientation aligned with the open pathway 112 of the connector 110. The positions of groove pairs on the lock pin 120 along its longitudinal axis are also misaligned with the designated spaces 134, 135, 136 in the housing body 130. In this configuration, the connection in the connecting hub 150 is fully secured. The connector 110 cannot be disconnected from its designated space 136 and, conversely, other connectors cannot be connected to designated spaces 134 and 135.

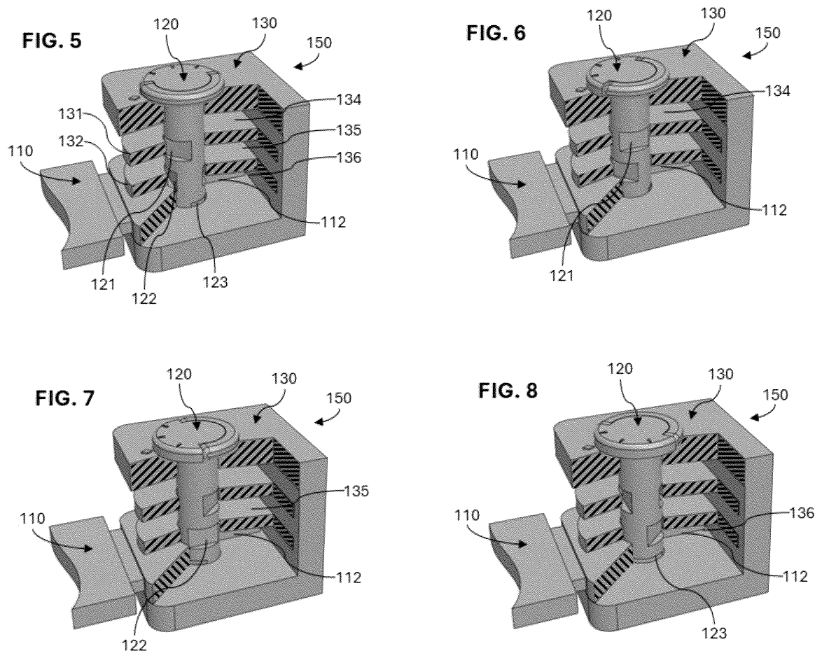

FIGS. 6, 7, and 8 show how the orientation of the groove pairs 121, 122, 123 change due to the rotation of the lock pin 120. In FIG. 6, the lock pin 120 is rotated counterclockwise one-eight of a turn when compared to FIG. 5, which makes the orientation of the top groove pair 121 aligned with the open pathway 112 of the open-end keyhole connector 110. In FIG. 7, the lock pin 120 is rotated another one-eight of a turn, this time aligning the orientation of the middle groove pair 122 with the open pathway 112. In FIG. 8, the lock pin 120 is rotated one more eight of a turn, aligning the orientation of the bottom groove pair 123 with the open pathway 112 of the connector 110. However, in all three configurations in FIGS. 6, 7, 8, the position of the groove pairs 121, 122, 123 are still misaligned vertically with the designated spaces 134, 135, 136, respectively, and thus the connection in the connecting hub 150 remains secure.

FIG. 9 shows the scenario when the embodiment in FIG. 8 has the lock pin 120 shifted upwards. In this setting, the positions of the groove pairs 121, 122, 123 are now aligned with the designated spaces 134, 135, 136, respectively. Since the bottom groove pair 123 also has their orientation aligned with the open pathway 112 of the open-end keyhole connector 110 in the designated space 136, the connection is now unsecured, and the connector 110 can disconnect/reconnect with the connecting hub 150 via the open pathway 112. Conversely, the orientations of the top and middle groove pairs 121 and 122 are not aligned with the preferred movement direction that allows the open-end keyhole connectors to connect/disconnect with the connecting hub, so the top and middle designated spaces 134 and 135 are still secured. This orientation differentiation, among other things, illustrates an advancement of this invention that provides the ability to pinpoint control over an individual connector among multiple open-end keyhole connectors to be handled in a connecting hub of this connection system.

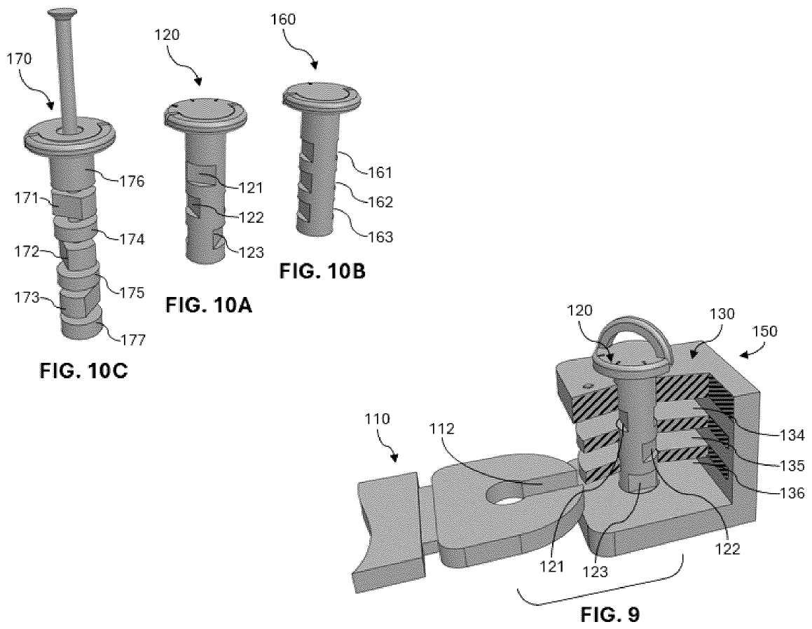

Different embodiments of this invention may use different configurations of lock pins. FIGS. 10A-10C show perspective views of three example variants of the lock pins. FIG. 10A shows the lock pin 120 of the embodiment in FIG. 1, with the three groove pairs 121, 122, 123 having different rotational orientations. FIG. 10B shows a different lock pin 160 with the three groove pairs 161, 162, 163 having identical rotational orientation. FIG. 10C illustrates a lock pin 170 that is adjustable, comprising several concentrically connected pieces rather than one solid piece. This version of the lock pin includes three groove pieces 171, 172, 173 separated by two separator pieces 174, 175 all housed inside two end pieces 176, 177. These pieces can be assembled into one lock pin via in-built rotatable interlocking features and/or a set of suitable fasteners. The orientation of the groove pieces can be adjusted for a more customizable connection system.

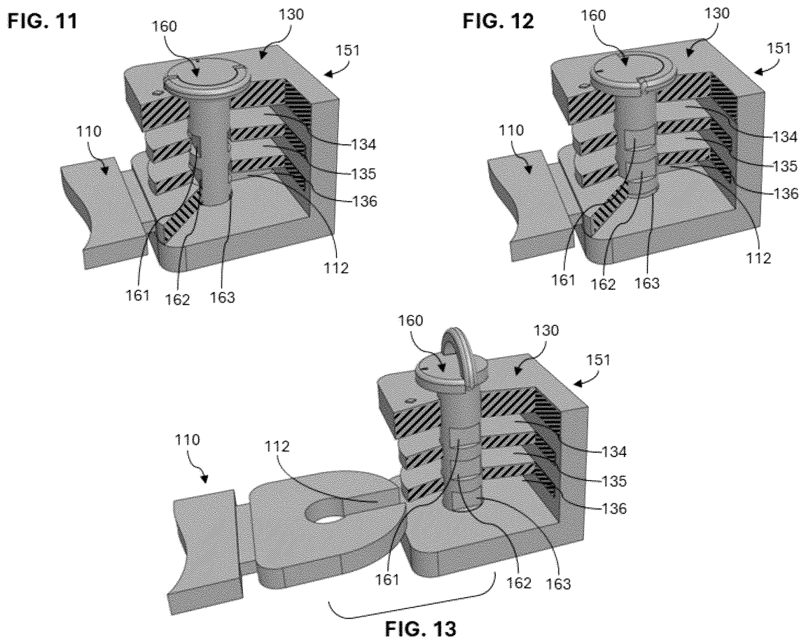

FIGS. 11-13 illustrate partially sectioned views of an embodiment similar to the one in FIG. 5, but with the connecting hub 151 having the lock pin 160 shown in FIG. 10B where the three groove pairs have identical rotational orientation. In FIG. 11, the lock pin 160 is in the base position in the housing body 130. The orientation of the groove pairs 161, 162, 163 on the lock pin do not match the direction of the open pathway 112 of the open-end keyhole connector 110. The positions of groove pairs along the axis of the lock pin are also misaligned with the stack layout of designated spaces 134, 135, 136 in the housing body 130. Thus, the connection in the connecting hub 151 is fully secured. In FIG. 12, the lock pin 160 has been rotated to have the orientation of the groove pairs 161, 162, 163 match the direction of the open pathway 112 of the open-end keyhole connector 110. However, the positions of the groove pairs 161, 162, 163 are still misaligned with the designated spaces 134, 135, 136, respectively, so the connection in the connecting hub 151 is still secured. Only when the lock pin 160 is also shifted upwards as shown in FIG. 13 is the connection unsecured. The shift aligns the positions of the groove pairs 161, 162, 163 with the designated spaces 134, 135, 136, allowing the connector 110 to disconnect/reconnect with any of the designated spaces in the connecting hub 151 via the connector's open pathway 112. For an implementation that prioritizes speed of operation, the setting shown in FIG. 12 can also be adopted as the base position for the lock pin 160, so that only shifting and not rotation is required to get to the unsecured state in FIG. 13.

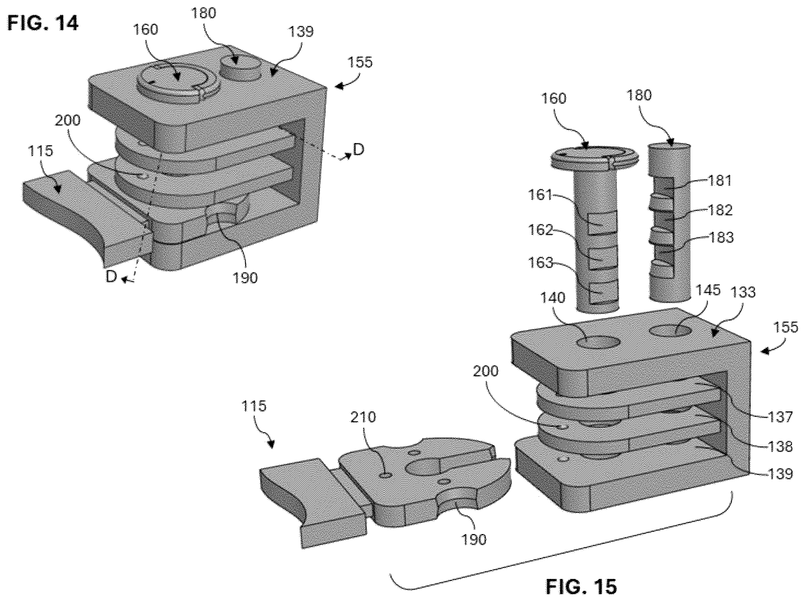

FIG. 14 illustrates an embodiment that takes the basic configuration from FIG. 1 but uses the lock pin 160 with additions of a rotation control pin 180 and detent units 200 to the connecting hub 155, as well as additions of rotation catch cutouts 190 and detent catches 210 to the open-end keyhole connector 115. FIG. 15 is an exploded view showing the components in FIG. 14 in full view. A set of detent units 200 are added to the housing body 133, and a set of detent catches 210 are added to the open-end keyhole connector 115 to provide tactile feedback during system operation. In addition to the lock pin 160, a rotation control pin 180 is added to the connecting hub 155, and another series of holes 145 is added to the housing body 133 as well as to its space retainers to accommodate the rotation control pin 180. The rotation control pin 180 has three grooves 181, 182, 183 that match the vertical spacing of the groove pairs 161, 162, 163 on the lock pin 160. The housing body 133 has three designated spaces 137, 138, 139. Lastly, a set of rotation catches 190 is added to the open-end keyhole connector 115.

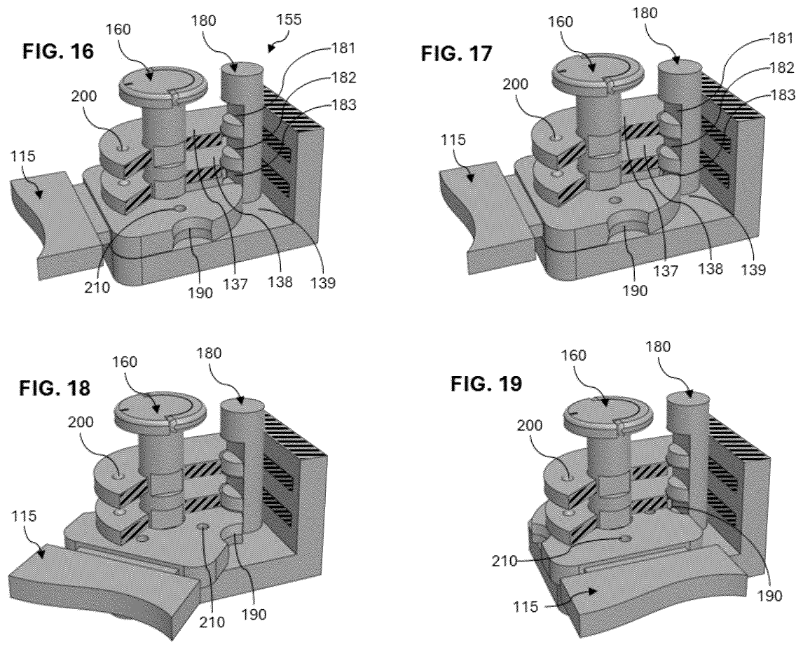

FIGS. 16-19 display partially sectioned views of FIG. 14, without the top panel of the housing body, where the housing body and space retainers are shown partially sectioned along line D-D, These figures illustrate how an additional rotation control feature is also offered in this invention. In FIG. 16, the lock pin 160 is in its base position, and the open-end keyhole connector 115 is securely connected with the connecting hub 155. The rotation control pin 180 is also in its base position, with its grooves 181, 182, 183 out of alignment with the designated spaces 137, 138, 139. The unaligned grooves act as a blockage that prevents the open-end keyhole connector 115 from rotating around the lock pin 160. In FIG. 17, the rotation control pin 180 has been shifted downwards to align the grooves 181, 182, 183 with the designated spaces 137, 138, 139, thus eliminates the blockage and allows the connector 115 to rotate. FIG. 18 shows the open-end keyhole connector 115 has rotated counterclockwise a few degrees around the lock pin 160. Lastly, FIG. 19 shows the scenario when the open-end keyhole connector 115 has rotated far enough for the rotation catch 190 to align with the rotation control pin 180. When the rotation control pin 180 shifts back to its base, unaligned, position as in FIG. 16, the rotation blockage is reinstated, and thus the connector 115 is locked in this position unable to rotate around the lock pin 160.

1. A connection system comprising:
at least one connector;
a connecting hub further comprising a lock pin and a housing body;
the connector having an open-end keyhole cutout comprising an inner hole and a pathway cutout from the edge of the connector to the inner hole;
the pathway cutout having a narrower width than the diameter of the inner hole;
the lock pin having a cross-section profile that has the same shape as the inner hole of the connector;
the lock pin having at least one groove in place perpendicular to its longitudinal axis resulting in a thinner core at the grooved section of the lock pin;
the housing body comprising a minimum of one top panel, one bottom panel, and one side panel, or equivalent connected structures;
the top panel and the bottom panel of the housing body having holes to accommodate the lock pin; and
the lock pin placed through the holes of the housing body and having the ability to rotate around its axis and/or shift along its axis to enable the connector to connect to or disconnect from the connecting hub without needing to disassemble the connecting hub.

2. The connection system as claimed in claim 1 comprising:
the housing body further comprising at least one space retainer affixed to the side panel of the housing body;
the space retainers defining designated spaces to house individual open-end keyhole connectors in the housing body with the number of designated spaces for individual connectors equaling the number of space retainers plus one;
the space retainers having holes that line up with the holes in the top and bottom panels of the housing body to accommodate the lock pin; and
the lock pin further having additional grooves spaced along its axis in a manner that corresponds to the stack layout of the designated spaces in the housing body.

3. The connection system as claimed in claim 1 wherein the lock pin is adjustable and further comprises:
two end pieces;
at least one groove piece;
all pieces concentrically connected via in-built rotatable interlocking features and/or a set of suitable fasteners, with the groove piece in between the two end pieces;
the two end pieces having a cross-section profile that has the same shape as the inner hole of the connector; and
the groove pieces having a thinner core than the end pieces.

4. The connection system as claimed in claim 2 wherein the lock pin is adjustable and further comprises:
two end pieces;
at least two groove pieces, with the number of groove pieces equaling the number of designated spaces for individual connectors in the housing body;
at least one separator piece, with the number of separator pieces equaling the number of space retainers;
all pieces concentrically connected via in-built rotatable interlocking features and/or a set of suitable fasteners, with the two end pieces on the two ends, a groove piece next to each end piece, and the groove separator pieces and remaining groove pieces alternating in the middle;
the two end pieces and the groove separator pieces having a cross-section profile that has the same shape as the inner hole of the connector; and
the groove pieces having a thinner core than the end pieces and separator pieces.

5. The connection system as claimed in claim 1 further comprising:
a rotation control pin having at least one groove in place perpendicular to its longitudinal axis resulting in a thinner core at the grooved section of the rotation control pin;
the top and bottom panels of the housing body having an additional set of holes to accommodate the rotation control pin;
the rotation control pin, while remaining assembled in the housing body, having the ability to shift along its longitudinal axis; and
the open-end keyhole connector further comprising at least one rotation catch cutout on the external circumference that partially conforms to the cross-section profile of the rotation control pin.

6. The connection system as claimed in claim 2 further comprising:
a rotation control pin having grooves in place with the same spacing as the grooves on the lock pin resulting in a thinner core at each grooved section of the rotation control pin;
the top and bottom panels and the space retainers on the housing body having an additional set of holes to accommodate the rotation control pin;
the rotation control pin, while remaining assembled in the housing body, having the ability to shift along its longitudinal axis; and
the open-end keyhole connector further comprising at least one rotation catch cutout on the external circumference that partially conform to the cross-section profile of the rotation control pin.
